(19) United States
(12) Patent Application Publication
(10) Pub. No.: US 2021/0271507 A1
(43) Pub. Date: Sep. 2, 2021

(54) APPARATUS, SYSTEM AND METHOD FOR AGENTLESS CONSTRAINT DETECTION IN THE CLOUD WITH AI

(71) Applicant: Joseph MATTHEW, Toowong, Queensland (AU)

(72) Inventor: Joseph MATTHEW, Toowong, Queensland (AU)

(21) Appl. No.: 17/255,265

(22) PCT Filed: Jul. 22, 2019
(86) PCT No.: PCT/AU2019/050760

§ 371 Date: Dec. 22, 2020

(30) Foreign Application Priority Data
Jul. 24, 2018 (US) 67702400

(51) Int. Cl. G06F 9/455; G06F 9/50; G06F 11/34; G06F 11/30; G06N 3/04

(52) U.S. Cl. CPC G06F 9/45558; G06F 9/5083; G06F 11/3433; G06F 2009/45595; G06N 3/04; G06F 2009/45591; G06F 2009/4557; G06F 11/301

(57) ABSTRACT

Cloud service providers provide a plurality of hosts that employ hypervisor technologies on virtual machines (VM) or cloud compute infrastructure for running applications. This invention deals with systems and methods for an agentless approach to identify constraints without an agent or access to the OS layer, through artificial neural networks from the metrics provided by the cloud vendors hypervisor system.

### BACKGROUND OF THE INVENTION

The ease of provisioning compute instances in the cloud along with the use of virtual machines (VM) with varying configurations of central processing unit (CPU), memory, storage and networking capacity has created an environment where there can be over allocation or under allocation of computing resources relative to the applications ability to use this capacity. Several approaches to matching this applications ability to use the computing power with the right cloud VM configuration are in the marketplace.

A prevalent approach for migrations to the cloud occur is with a lift and shift style migration where VMs from on premises data centers are migrated to the cloud where there is another configuration of VM provided by the cloud vendors. The typical cloud computing approach has been to select a VM configuration that most closely matches based on estimation of the capacity requirements of the target application.

Cloud vendors use a multitude of virtual machine types on a shared infrastructure leveraging hypervisor technologies. Cloud vendors encrypt the application data running on VMs, and further ensure there isn't any access to memory on such shared infrastructure to protect customer data.

Cloud providers report metrics and analytics such as CPU, I/O device, network packets but lack memory insights, which are accessible only through the operating system (OS) layer. It is inherently challenging to derive memory insights from cloud analytics due to shared access to memory across hardware that are partitioned by VMs, potential exposure to customer sensitive in-memory data, or private key secured access (or hashed by the OS) to the memory layer from the operating system. Because of these limitations it is common for cloud analysis software to employ an agent on top of the OS or add a layer to the hypervisor to obtain detailed memory insights or access these metrics directly from the OS layer.

### SUMMARY OF THE INVENTION

This invention deals with systems and methods for an agentless approach to identify system constraints without an agent or access to the OS layer, through artificial neural networks from the metrics provided by the cloud hypervisor system.

Cloud service providers provide a plurality of compute infrastructure configurations that employ variations of hypervisor or virtual machines (VM) or both to provide a platform for applications to run in the cloud. These hypervisors can run directly on system hardware known as “bare metal” or can be embedded hypervisor on VM that support a plurality of deployed operating systems. This invention deals with systems and methods for an agentless approach to identify constraints without the use of an agent or access to the OS layer, that typically require access to OS private keys.

Accordingly, in one embodiment of the invention there is provided a method of evaluating metrics cloud computing requirement comprising:

receiving cloud computing performance data;

processing said data to obtain a performance model;

predicting one or more performance requirements based on the obtained performance model.

In some implementations of the invention, the cloud computing metrics are in relation to a virtualization layer and in some the data is obtained from a source which is not an agent. In some embodiments, the data is obtained directly from a hypervisor layer.

Some implementations of the invention comprise the step of identifying a suitable cloud computing resource for the cloud computing requirement.

The data may be of any suitable type, for example, in some embodiments, the data comprises one or more of CPU metrics, root storage device percentage throughput capacity, root storage device disk queue length, other storage device percentage throughput capacity, and other storage device disk queue length.

Additional steps may be added to preferred embodiments, for example, the method may further comprise one or more of a data cleansing step, a training step, a feature scaling step, a dimensionality adjustment step, a hyperparameter optimization step, a model selection step, a weighting step, a regression model step, and a testing step.

In another embodiment of the invention, there is provided a system for evaluating cloud computing metrics comprising:

a storage module;

a processing module;

a memory module;

an AI prediction system module; and

a communication module;

wherein the communication module communicates data directly between a hypervisor layer and the AI prediction system module. The hypervisor layer may be either part of, or nor part of the system of the invention. Some embodiments of the system further comprise a hypervisor layer. In some embodiments there is a hyperlayer external to the system itself from which the data is communicated.

In some implementations of the system the data may comprise performance data in relation to one or more of a virtual disk, a virtual CPU and/or a virtual memory.

In another embodiment of the invention, there is provided a method for memory constraint detection or memory utilization prediction from the hypervisor layer of a computing device or a cloud virtual machine comprising:

building or using an Artificial Neural Network (ANN) or Machine Learning (ML) model for an analysis or a recommendation service, a first plurality of metrics for each of a plurality of virtual hosts available for executing the workload or application, each of the first plurality of metrics identifying a current level of load on a respective one of the plurality of virtual hosts.

retrieving, by the analysis engine, a third plurality of metrics associated with a virtual machine, each of the third plurality of metrics identifying a level of load placed on a respective virtual machine during a time period prior to the current time period.

assigning, by the analysis engine, a score to each of the plurality of virtualized hosts to maximize performance of the identified virtual machine, responsive to the retrieved first, second, and third pluralities of metrics and to the determined level of priority; and

transmitting, by the host recommendation service, an identification of one of the plurality of virtual hosts on which to execute the virtual machine.

It will be appreciated that this method of the invention is particularly suited to a computing device or a cloud virtual machine comprising a virtual host recommendation service or advisory services with over allocation or under allocation of resources.

In a further embodiment of the invention, there is provided a method for evaluating metrics from a hypervisor cloud metrics provider in order to select a virtual machine for execution of an application workload, comprising:

use of a root device or secondary storage disk queue length metric to predict memory constraints typically available from the virtual machine operating system metric through the use of an agent; and

use of a root device storage throughput or secondary storage device throughput to predict memory constraints typically available from the virtual machine operating system metric through the use of an agent;

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram depiction of an embodiment with major components of cloud computing environment with physical hardware, different types of hypervisor and multiple VMs, one of which has an agentless approach to predict constrained system resources.

FIG. 2 is a flow chart illustrating an embodiment of a VM host recommendation engine to match resources utilization metrics from the hypervisor to a cost aware appropriate VM type from a cloud inventory of VM types.

FIG. 3 is a block diagram depicting an embodiment of an artificial intelligent model for predicting constrained resources around memory, and is another embodiment of this invention.

FIG. 4 is a block diagram variant depiction of an embodiment with major components of cloud computing environment with physical hardware, different types of hypervisor and multiple VMs, where the agent component or software addition is part or close to the hypervisor layer to arrive at an agentless approach to predict constrained system resources.

FIG. 5 is a detailed process and flow chart of the steps to build and deploy an AI or ML based virtual host recommendation engine that learns the unknown metric of memory from the exposed cloud metrics and does not require an agent on either the hypervisor layer or the operating system.

FIG. 6 depicts cloud-computing components with an embodiment of the present invention.

FIG. 7 is an alternate process and flowchart of a process for advising and optimizing resources included in this invention.

### DETAILED DESCRIPTION OF EXEMPLARY EMBODIMENTS

It is convenient to describe the invention herein in relation to particularly preferred embodiments. However, the invention is applicable to a wide range of embodiments and it is to be appreciated that other constructions and arrangements are also considered as falling within the scope of the invention. Various modifications, alterations, variations and or additions to the construction and arrangements described herein are also considered as falling within the ambit and scope of the present invention.

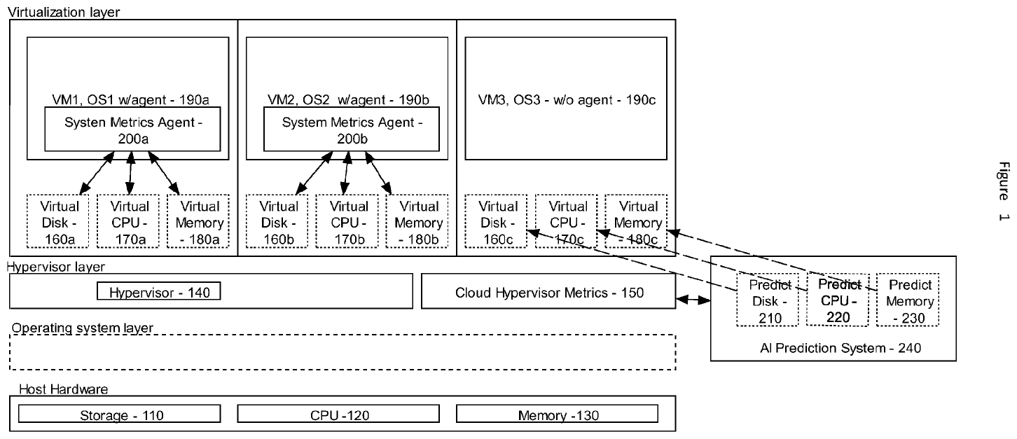

Referring now to FIG. 1, a block diagram depicts one embodiment of a virtualized computing environment. In brief overview, a computing device has a host hardware layer that is composed of a type of storage 110, a central processing unit CPU 120, and some amount of memory 130. Virtualization enables software type access to these physical components, and requires changing the mindset from physical to logical. Virtualization enables creating more logical computing resources, called virtual systems, within one physical computing device. It most commonly uses a hypervisor layer 140 for managing the physical resources for every virtual system, providing protected memory spaces. The hypervisor is a software that can virtualize the hardware resources.

In another embodiment called “bare metal” that employs minimal to no operating system layer between the physical computing layer and the hypervisor, called type 1 hypervisor. Examples of this type of hypervisor include but are not limited to VMware ESX, Microsoft Hyper-V, Citrix XenServer, Oracle VM, KVM. The open-source KVM (or Kernel-Based Virtual Machine) is a Linux-based type-1 hypervisor that can be added to most Linux operating systems including Ubuntu, Debian, SUSE, and Red Hat Enterprise Linux, but also Solaris, and Windows.

Yet another type of hypervisor called Type 2 hypervisor: run on a host operating system that provides virtualization services, such as I/O device support and memory management. Examples of this type of virtualization include but are not limited to VMware Workstation/Fusion/Player, VMware Server, Microsoft Virtual PC, Oracle VM VirtualBox, Red Hat Enterprise Virtualization.

Cloud providers provide Cloud Hypervisor Metrics 150 from this hypervisor layer that include utilization metrics for CPU, storage, networking layer but does not have any memory utilization metrics due to the shared nature of memory in this virtualized environment, and also to protect the in-memory contents from being exposed to neighboring virtualized systems.

Within a virtualized environment different types of Operating systems—Windows, Linux flavors can run in protected spaces as shown in 190a, 190b and 190c. Each operating system can provide some amount of metrics on the utilization of CPU 170a, 170b, 170c, Memory 180a, 180b, 180c, Storage 160a, 160b,160c. These operating system metrics are exposed to external systems through an installed software or an agent shown as 200a, 200b.

The AI prediction system 240 in such a virtualized environment is able to predict the storage or disk 210, CPU 220 and memory 230 from just the exposed metrics provided by the cloud hypervisor metrics 150 without installing any agents or accessing the protected memory space of the virtual machine 190c and represents an embodiment of this invention shown in FIG. 1.

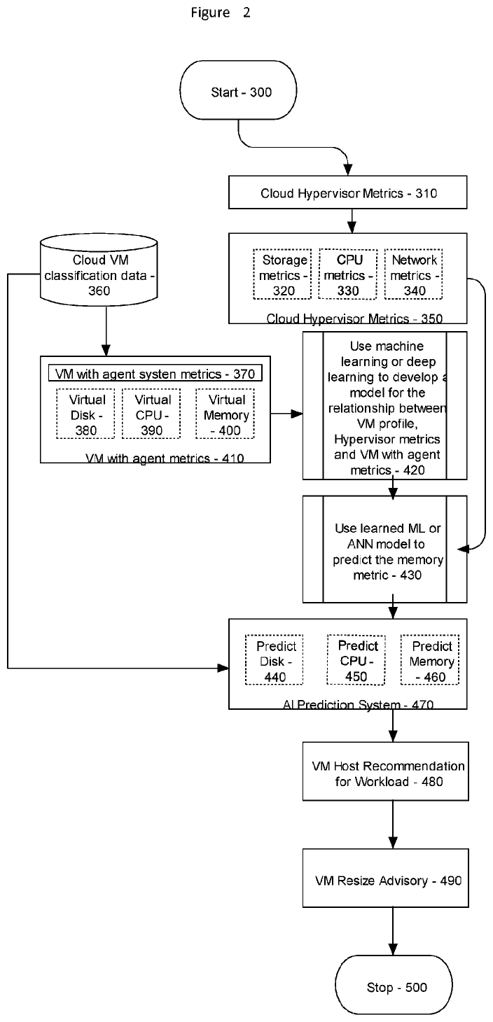

Referring now to FIG. 2, a flow diagram depicts one embodiment of a method for this invention with the cloud hypervisor metrics system 310 to expose certain metrics—storage 320, CPU 330 and networking metrics 340.

In this example embodiment the training model for the machine learning or artificial neural network include some cloud VM classification data 360 and a virtual machine with an agent 410. This virtual machine 360 with an agent 370 can expose to the external system the extent of CPU computing capability utilized by the workload/application 390, memory availability 400, storage 380 and or networking metrics. In this embodiment machine learning or artificial neural networks take this VM metrics from installed agent 410 along with the classification data from the cloud providers 360 to arrive at a Machine Learning (ML) or an Artificial Neural Network (ANN) model 430. This model 430 with its training data can then be used with the cloud hypervisor metrics 350 to predict the storage 440, CPU 450 and in particular the memory metric 460 without use of an agent on the virtual machine.

The output of the AI prediction system 470 can utilise classification or logical data to guide in the selection of the virtual machine type best suited for that worked 480 optionally including an advisory 490 to guide a user to upgrade or downgrade a virtual machine or can be automated.

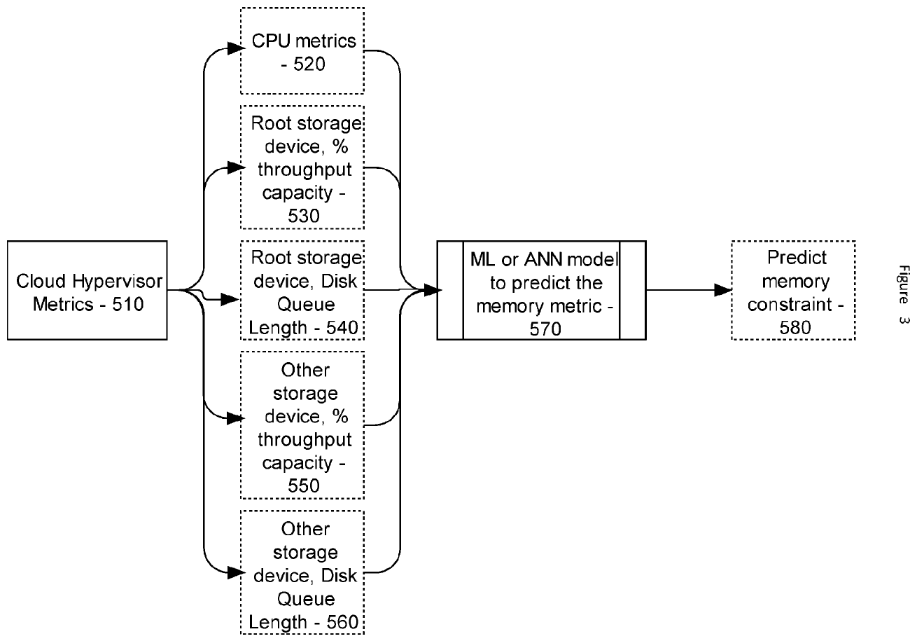

In a more detailed embodiment FIG. 3 of this artificial neural network or machine learning model the input parameters used include CPU metric 520 from the cloud hypervisor metric 510, root device throughput capacity 530, the root storage device disk queue length 540 which has a high correlation to predict the unknown memory constraint 580. Other input parameters from this cloud hypervisor metrics 510 can include secondary storage device throughput capacity 550, and other storage device disk queue length 560. The trained artificial neural network or machine learning model 570 can predict with a degree of accuracy from the training dataset the memory constraint 580 of the virtual machine without use of an agent.

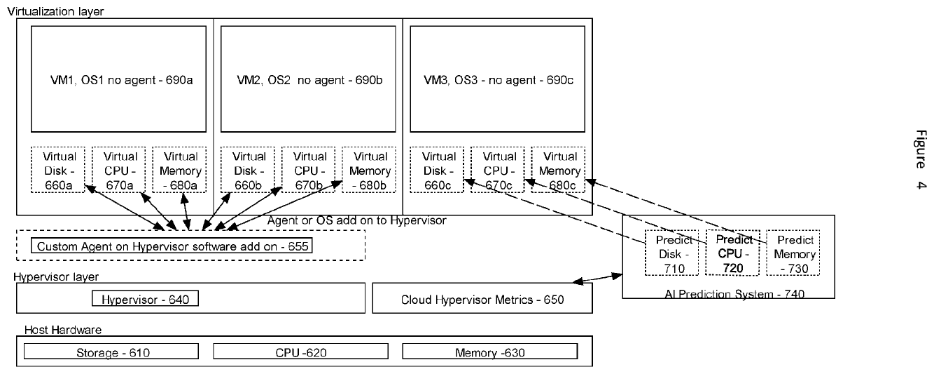

FIG. 4 is a block diagram depiction of an embodiment with major components of cloud computing environment with physical hardware, different types of hypervisor and multiple VMs, where the agent component or software addition is part of or close to the hypervisor layer to arrive at an agentless approach to predict constrained system resources. In brief, a computing device has a host hardware layer that is composed of a type of storage 610, a central processing unit CPU 620, and some amount of memory 630. It most commonly uses a hypervisor layer 640 for managing the physical resources for every virtual system, providing protected memory spaces. In this type of embodiment, rather than the agent being added to the operating system, an agent or custom software component is added, shown in 655.

Within a virtualized environment different types of Operating systems—Windows, Linux flavors can run in protected spaces as shown in 690a, 690b and 690c. Each operating system provides some amount of metrics on the utilization of CPU 670a, 670b, 670c, Memory 680a, 680b, 680c, Storage 660a, 660b,660c. These operating system metrics are exposed to the custom agent or hypervisor software layer, 655.

The AI prediction system 740 in such a virtualized environment is able to predict the storage or disk 710, CPU 720 and memory 730 from just the exposed metrics provided by the cloud hypervisor metrics 650 without installing any agents or accessing the hypervisor layer of the virtual machine 655 and represents an embodiment of this invention shown in FIG. 4.

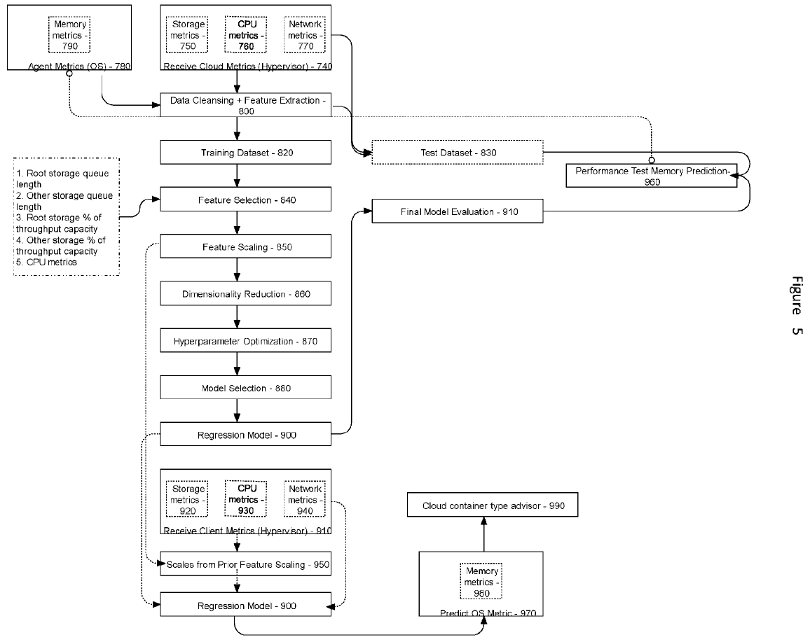

FIG. 5 is a detailed process and flow chart of the steps to build and deploy an AI or ML based virtual host recommendation engine that learns the unknown metric of memory from just the cloud metrics and does not require an agent on either the hypervisor layer or the operating system. To build a model (regression model 900 or the final model 910), the cloud hypervisor data (without any agent) shown as 740 with the metrics on storage 750, CPU 760 and Network 770 along with the OS layer metric (with an agent) Memory metrics 790 is used to start building the final model 910, using some aspects of supervised learning.

A data cleansing and feature extraction process show in 800 is performed, though not required to cleanse the data from any missing or incorrect dataset provided from the hypervisor layer 740 or the OS layer 780. Imputation is another strategy for dealing with missing data or replacement of missing data values using certain statistics rather than complete removal. This cleaned data can then be split into Training data set 820 and/or Test data set 830. The proportions of data allocated for test optimally range from 50% to 90% allocated toward testing purposes. As part of feature selection 840, any subset of these features—Root storage queue length, Other storage queue length, Root storage % of throughput capacity, Other storage % of throughput capacity and or CPU metrics are part of this invention for the purposes of predicting memory constraints of the virtual layer in a cloud environment. Dimensionality reduction 860 is an optional step in this process that involves a transformation of the data. The purpose of this is to remove noise, increase computational efficiency by retaining only useful information and avoid over fitting.

A subsequent optional step is hyper parameter optimization 870 to arrive at a learning algorithm to predict the memory utilization. Model selection 880 and the regression model 900 can employ any number of different learning algorithms such as Support Vector Machines (SVM), Bayes classifiers, Artificial Neural Networks (ANN), linear learners, decision tree classifiers or other such statistical models as part of this invention. The final model developed 910 is used against the test dataset 830 to arrive at the model used for subsequent operations. Acceptable metrics for performance as compared against actual as part of 960 to measure the effectiveness of the model's ability to predict memory from the hypervisor metrics.

With an acceptable model, new client metrics 910 that contain storage 920, CPU 930 and network 940 are cleansed using the same scales from the prior feature scaling exercise 950 along with the validated regression model 900 to predict the memory metric 980 of the OS layer without an agent. The recommendation engine leverages this data to provide a cloud container type advisory 990 shown in Figure E.

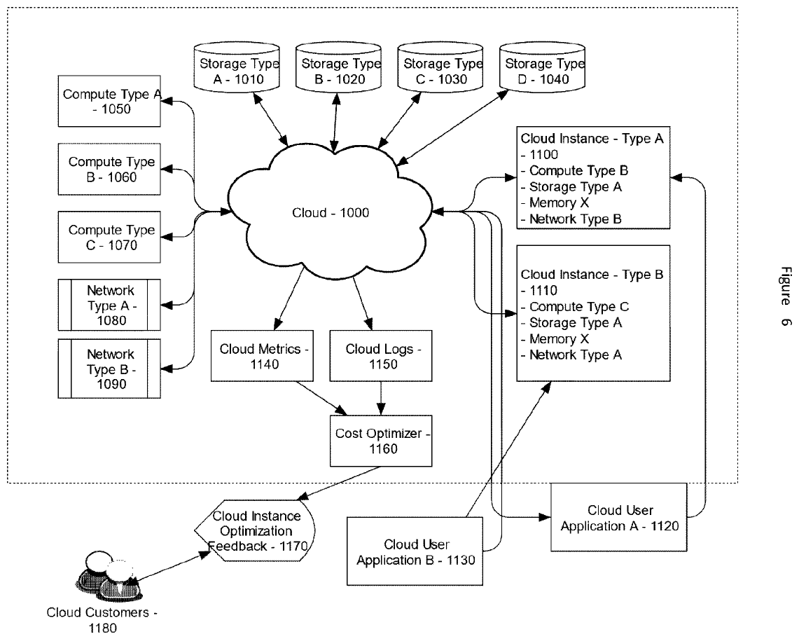

FIG. 6 depicts example cloud-computing components with an embodiment of the present invention. A cloud providers cloud 1000 can contain various types of compute (CPU) shown as Type A, B, C 1050, 1060, 1070 along with various types of storage types A, B, C, D 1010, 1020, 1030, 1040 and various types of networking types 1080 and 1090. Within the cloud provider's infrastructure these types of storage, compute, and network are grouped together into instance types with an amount of memory shown as 1100 and 1110. Cloud customers 1180 run applications in the cloud on these cloud instance types, application A 1120 and 1130. The cloud provider provides some container level metrics 1140 and logs 1150. This invention in Figure F shown as Cost Optimizer 1160 reads this cloud metrics and logs and is able to provide cloud instance optimization feedback on visual interface 1170 to the cloud customers 1180.

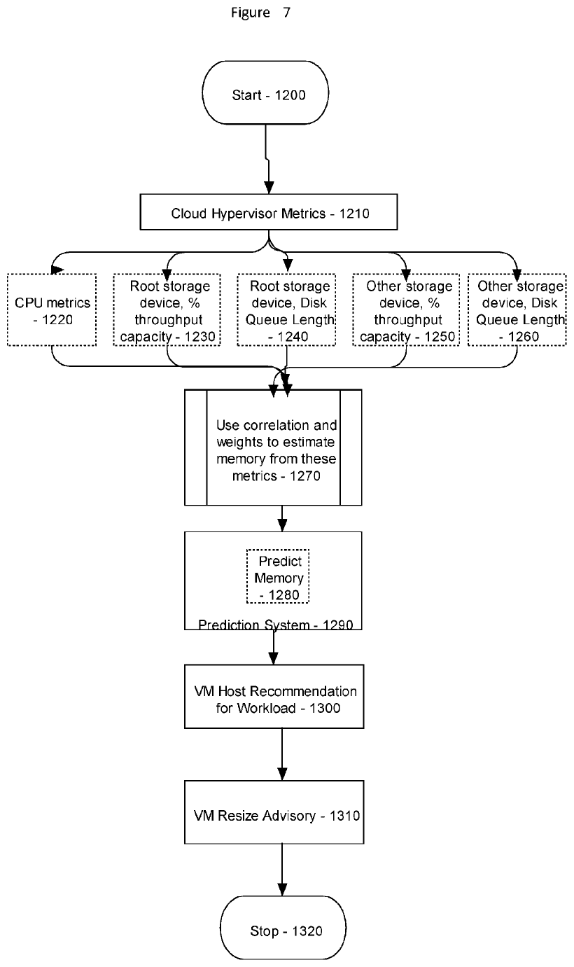

FIG. 7 is an alternate process and flowchart of a process for advising and optimizing resources also included in this invention. In this arrangement cloud hypervisor metrics 1210 that contain CPU 1220, root storage device throughput capacity 1230, root storage device queue length 1240 other storage device throughput 1250 and other storage device queue length 1260. Correlation of these metrics with weights obtained by alternate methods can be applied to develop a prediction system 1290 that does not use Machine Learning (ML) or Artificial Intelligence (AI) are also included as part of this invention when used for the purposes of predicting memory 1290 and develop a VM host recommendation engine from the workload 1300 to provide a VM resize advisory 1310.

1. A method of evaluating metrics cloud computing requirement comprising:
receiving cloud computing performance data;
processing said data to obtain a performance model;
predicting one or more performance requirements based on the obtained performance model.

2. A method according to claim 1 wherein the cloud computing metrics are in relation to a virtualization layer.

3. A method according to claim 1 wherein the data is obtained from a source which is not an agent.

4. A method according to claim 1 wherein the data is obtained directly from a hypervisor layer.

5. A method according to claim 1 further comprising the step of identifying a suitable cloud computing resource for the cloud computing requirement.

6. A method according to claim 1 wherein the data comprises one or more of CPU metrics, root storage device % throughput capacity, root storage device disk queue length, other storage device % throughput capacity, and other storage device disk queue length.

7. A method according to claim 1 wherein the method further comprises one or more of a data cleansing step, a training step, a feature scaling step, a dimensionality adjustment step, a hyperparameter optimization step, a model selection step, a weighting step, a regression model step, and a testing step.

8. A system for evaluating cloud computing metrics comprising:
a storage module;
a processing module;
a memory module;
a hypervisor layer;
an AI prediction system module; and
a communication module;
wherein the communication module communicates data directly between the hypervisor module and the AI prediction system module.

9. A system according to claim 8 wherein the data comprises performance data in relation to one or more of a virtual disk, a virtual CPU and/or a virtual memory.

10. A method for memory constraint detection or memory utilization prediction from the hypervisor layer of a computing device or a cloud virtual machine comprising a virtual host recommendation service or advisory services with over allocation or under allocation of resources, the method comprising:
building or using an ANN or ML model for an analysis or a recommendation service, a first plurality of metrics for each of a plurality of virtual hosts available for executing the workload or application, each of the first plurality of metrics identifying a current level of load on a respective one of the plurality of virtual hosts.
retrieving, by the analysis engine, a third plurality of metrics associated with a virtual machine, each of the third plurality of metrics identifying a level of load placed on a respective virtual machine during a time period prior to the current time period.
assigning, by the analysis engine, a score to each of the plurality of virtualized hosts to maximize performance of the identified virtual machine, responsive to the retrieved first, second, and third pluralities of metrics and to the determined level of priority; and
transmitting, by the host recommendation service, an identification of one of the plurality of virtual hosts on which to execute the virtual machine.

11. A method for evaluating metrics from a hypervisor cloud metrics provider in selecting a virtual machine for execution of an application workload, comprising:
use of a root device or secondary storage disk queue length metric to predict memory constraints typically available from the virtual machine operating system metric through the use of an agent; and
use of a root device storage throughput or secondary storage device throughput to predict memory constraints typically available from the virtual machine operating system metric through the use of an agent.
